(19) United States
(12) Patent Application Publication
(10) Pub. No.: US 2010/0129530 A1
(43) Pub. Date: May 27, 2010

(54) METHOD FOR MANUFACTURING FLAT PANEL DISPLAY

(76) Inventor: Masahiro Watabe, Miyazaki (JP)

Correspondence Address: MILES & STOCKBRIDGE PC, 1751 PINNACLE DRIVE, SUITE 500, MCLEAN, VA, 22102-3833, US

(21) Appl. No.: 12/089,348

(22) PCT Filed: Dec. 16, 2005
(86) PCT No.: PCT/JP2005/023165

§ 371 Date: Apr. 4, 2008

(51) Int. Cl. B05D 5/12

(52) U.S. Cl. 427/69

(57) ABSTRACT

A method for manufacturing a flat panel display (1) includes the steps of depositing an insulator (17a) by a chemical vapor deposition on a substrate (111) on which an electrode group (40) having first and second terminal parts (41 and 42) is formed, in the state where one terminal part (41) of the first and the second terminal parts (41 and 42) is masked that is less affected by the masking than the other terminal part while the other terminal part (42) is not masked, and removing at least a part of the insulator (171) deposited on the terminal part (42) that is not masked.

### TECHNICAL FIELD

The present invention relates to a process for manufacturing a flat panel display in which coating of electrodes is performed by a chemical vapor deposition process.

### BACKGROUND ART

The chemical vapor deposition (CVD) process is a method for forming a film from a source gas by a chemical reaction, which is widely used for industrial applications including formation of a thin film of a micro device such as a semiconductor device and coating of an object in the order of meters.

The CVD process has recently been used also for manufacturing a flat panel display having a large screen of one meter diagonal size or larger. Japanese Patent No. 3481142 describes a method for manufacturing an AC plasma display panel in which a dielectric layer for coating electrodes is formed by a plasma CVD process. According to the CVD process, it is possible to obtain a dielectric layer having a thin and uniform thickness. In addition, compared to a thick film process, it is possible to form the dielectric layer made of a material such as silicon dioxide or organic silicon oxide having a smaller relative dielectric constant than a low melting point glass as a common material at low temperatures.

A plasma CVD device of a parallel plate type is suitable for forming a film on a relatively large object such as a substrate of a flat panel display. This type of device includes an upper electrode that also works as a nozzle for spouting source gas uniformly in a wide range and a lower electrode that also works as a bed for supporting the object, so that plasma is generated between the object on the lower electrode and the upper electrode.

If the object has a part not to be coated in the CVD process for forming a film, masking of the part is performed. Japanese unexamined patent publication No. 2003-324075, which is a related-art document about masking, discloses a masking member that is a combination of a rectangular frame and a thin band-like member.

[Patent Document 1] Japanese Patent No. 3481142

[Patent Document 2] Japanese unexamined patent publication No. 2003-324075

### DISCLOSURE OF THE INVENTION

If a mask is put on the substrate for masking so as to make terminal parts of electrodes be exposed in the manufacturing process of a plasma display panel in which a dielectric layer having a thickness of approximately a few microns to 20 microns is formed by the CVD process on the substrate on which the electrodes are arranged, a thickness of the dielectric layer may be not uniform. More specifically, as shown in FIGS. 1(A) and 1(B), a vicinity of the mask may be extremely thicker than other parts. FIGS. 1(A) and 1(B) both show cases where a film is formed on both sides of the mask. However, the film becomes thick on both side of the mask in FIG. 1(A) as shown with the curves a1 and a2 while it becomes thick on one side of the mask in FIG. 1(B) as shown with the curve a4. The curve a3 shows that the thickness of the film is uniform on the other side of the mask. In FIG. 1(A), the source gas flows from the center of the mask to both sides, so both the left and the right end rims of the mask in FIG. 1(A) are located on the downstream sides of the gas flow with respect to the center of the mask. In FIG. 1(B), the source gas flows from the left end to the right end of the mask, so that the left end rim of the mask is located on the upstream side of the gas flow with respect to the center of the mask while the right end rim of the mask is located on the downstream side with respect to the same. The thickness of the part that is locally thick may be up to two times the thickness of the part that is away from the mask and has a uniform thickness (a set value of the film forming thickness). A range of the part that is locally thick corresponds to a range where the distance from the mask is approximately 2 to 3 mm.

A cause of this local increase of the film thickness may be that a flow of the source gas in the reaction chamber from an inlet hole to an exhaust hole is interfered by the mask resulting in change of a speed of the flow at the end rim of the mask.

Unevenness of the thickness of the dielectric layer may cause a variation of an operational characteristic among cells of the screen. In order that high quality and stable display is performed, it is desirable that the thickness of the dielectric layer be uniform.

However, if the masking is not performed, the dielectric layer must be removed partially so that terminal parts of the electrodes are exposed after the dielectric is deposited so as to cover the entire of the electrodes. For example, a wet etching process should be performed. Addition of such a process may increase a turnaround time and a cost for manufacturing. In other words, the productivity may be decreased.

It is an object of the present invention to secure uniformity of the film thickness and to improve productivity of the electrode coating by the chemical vapor deposition process.

A method for manufacturing a flat panel display for achieving the object of the present invention includes the steps of forming an electrode group having first and second terminal parts on a substrate, depositing an insulator by the chemical vapor deposition method on the substrate on which the electrode group is formed in the state where one of the first and the second terminal parts is masked that is less affected by the masking than the other terminal part while the other terminal part is not masked, and removing a whole or part of the insulator deposited on the terminal part that is not masked.

The insulator that should be removed after the chemical vapor deposition is less in the case where one of the two terminal parts is masked than in the case where none of them is masked. By a simple consideration, the insulator to be removed in the former case is a half of that in the latter case. Therefore, time and cost necessary for the removing process can be reduced.

If the electrode group includes terminal parts with a common terminal connected to a plurality of electrodes and terminal parts without the same, it is desirable that the terminal parts without the common terminal be masked and the terminal parts with the common terminal be masked. If at least a part of the common terminal is exposed, electric connection of the plurality of electrodes corresponding to the common terminal can be performed. On the contrary, each terminal corresponding to one electrode should be exposed substantially entirely for securing electric connection of the electrode. In other words, the removing process of the insulator should be performed with high accuracy.

### BRIEF DESCRIPTION OF THE DRAWINGS

FIGS. 1(A) and 1(B) are diagrams showing a relationship between a mask and a film thickness in the conventional film forming process.

FIG. 2 is an exploded perspective view showing an example of a cell structure of a plasma display panel.

FIG. 3 is a plan view showing a first example of a display electrode pattern.

FIG. 4 is a plan view showing a region to be exposed of a display electrode group.

FIG. 5 is a plan view of a mask.

FIG. 6 is a plan view of the mask and a frame for supporting the same.

FIG. 7 is a schematic diagram showing a general structure of a plasma CVD device.

FIGS. 8(A)-8(F) are diagrams showing a manufacturing process of the plasma display panel.

FIG. 9 is a plan view showing a second example of the display electrode pattern.

FIG. 10 is a plan view showing a region to be exposed in the second example of the display electrode pattern.

FIG. 11 is a plan view showing a variation of the masking.

### BEST MODE FOR CARRYING OUT THE INVENTION

Hereinafter, a method of the present invention for manufacturing a plasma display panel as an example of the flat panel display will be described.

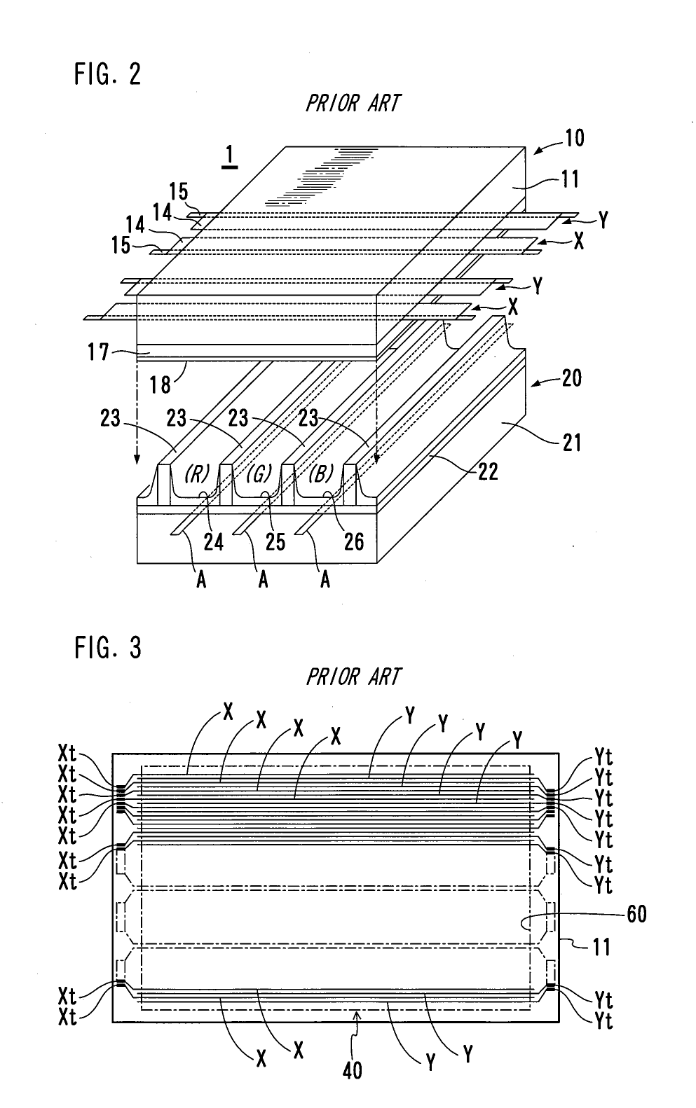

A typical plasma display panel has a cell structure as shown in FIG. 2. FIG. 2 shows a part including six cells corresponding to three columns in two rows, in which a front plate 10 and a rear plate 20 are separated for easy understanding of the internal structure.

The plasma display panel 1 includes the front plate 10, the rear plate 20 and discharge gas (not shown). The front plate 10 includes a glass substrate 11, first row electrodes X, second row electrodes Y, a dielectric layer 17, and a protection film 18. Each of the row electrodes X and the row electrodes Y is a laminate of a patterned transparent conductive film 14 and a metal film 15. The rear plate 20 includes a glass substrate 21, column electrodes A, a dielectric layer 22, a plurality of partitions 23, a red (R) fluorescent material 24, a green (G) fluorescent material 25, and a blue (B) fluorescent material 26.

As display electrodes for generating surface discharge, the row electrodes X and the row electrodes Y are arranged alternately on the inner surface of the glass substrate 11 and are covered with the dielectric layer 17 and the protection film 18. The dielectric layer 17 is an essential element for the AC plasma display panel, which corresponds to the insulator layer of the present invention. The coating with the dielectric layer 17 enables surface discharge to be generated repeatedly by utilizing wall charge accumulated in the dielectric layer 17. The protection film 18 protects the dielectric layer 17 from sputtering.

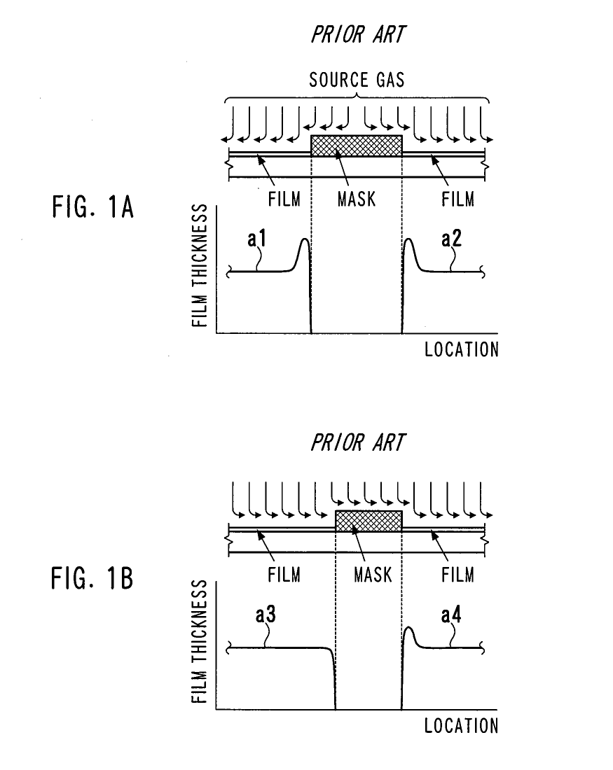

Note that either one of the well-known arrangement forms of the row electrodes can be adopted in the embodiment of the present invention. One of them is as shown in FIG. 1, in which an electrode gap between neighboring rows is larger than an electrode gap in each row (i.e., a surface discharge gap). The other arrangement has a uniform row electrode gap for all rows.

FIG. 3 is a plan view showing a layout pattern of the display electrodes. The row electrodes X and the row electrodes Y that constitute a display electrode group 40 extend from the screen 60 to the vicinity of the edge of the glass substrate 11, and terminals Xt and Yt are disposed at the end of them for electric connection with a drive unit. In FIG. 3, the terminals Xt of the row electrodes X are disposed on the left end side of the glass substrate 11, while the terminals Yt of the row electrodes Y are disposed on the right end side of the glass substrate 11. An arrangement pitch of the terminals Xt is different from an arrangement pitch of the row electrodes X on the screen 60, so the left end parts of the row electrodes X (including the terminals Xt) are patterned in shapes like curved bands. This curved part is not the laminate of the transparent conductive film 14 and the metal film 15 but is made of only the metal film 15. In the same manner, the right end parts of the row electrodes Y (including the terminals Yt) are patterned in shapes like curved bands, and this curved part is made of only the metal film 15.

The plasma display panel 1 having the structure described above is manufactured according to the procedure in which the front plate 10 and the rear plate 20 are made separately and after that they are glued to each other. In general, a mother glass plate having an area twice or more of the glass substrate 11 is used for manufacturing the front plate 10, so that a plurality of front plates 10 are made at one time. In the same manner, a plurality of rear plates 20 are made at one time. Prior to gluing the front plate 10 and the rear plate 20 together, the mother glass plate is divided so that each of the front plates 10 is glued to each of the rear plates 20 to be one unit.

In the manufacturing process of the front plate 10, the dielectric layer 17 is formed by the CVD process, in which either the terminals Xt or the terminals Yt are masked. If the masking is not performed, the entire of the display electrode group 40 including both the terminals Xt and the terminals Yt will be covered with the dielectric layer 17 having a uniform thickness. Then, it will take a long time to make the terminals Xt and Yt be exposed by an etching process or a sanding process. Since the masking is performed, a part of the dielectric layer 17 to be removed is decreased so that both the terminals Xt and the terminals Yt can be exposed in a relatively short time so that electric connection of them can be performed.

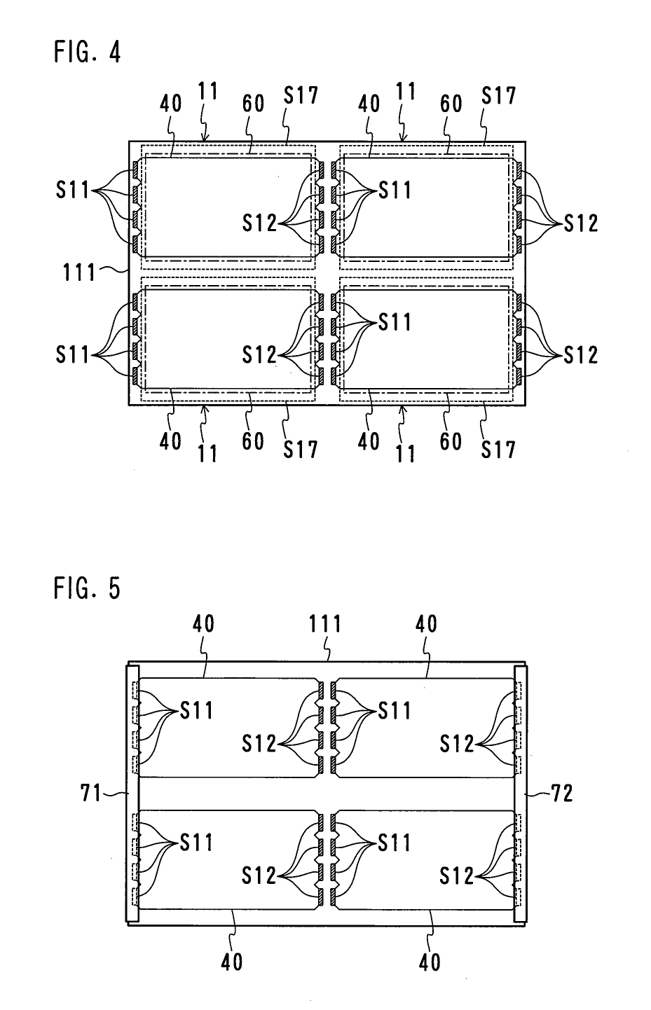

If four glass substrates are obtained from one mother glass plate (four in one) as an example, the region S11 and the region S12 shown in FIG. 4 should be exposed for electric connection between the plasma display panel 1 and a driving circuit. In FIG. 4, four display electrode groups 40 are formed in two rows on a rectangular mother glass plate 111. The part of mother glass plate 111 on which the display electrode group 40 is disposed and the vicinity thereof correspond to the glass substrate 11 on the front side of one plasma display panel. The region S11 corresponds to the terminal parts on the left side (left end part) in FIG. 4 of each of the display electrode groups 40 while the region S12 corresponds to the terminal parts on the right side (right end part) in FIG. 4 of each of the display electrode groups 40. Note that the region S17 in FIG. 4 is a region in which the dielectric layer should be formed.

In this example, four terminal parts that are close to the center of the mother glass plate 111 out of the total eight terminal parts are not masked while other terminal parts are masked. The masking is performed by using two masks 71 and 72 as shown in FIG. 5.

These masks 71 and 72 are elongated band-like plates made of an insulation material such as a ceramic or a heat-resistant glass and are disposed so as to overlap the mother glass plate 111 at the end parts. More specifically, the mask 71 is used for masking the left end parts of the two display electrode groups 40 located on the left side in FIG. 4, and the mask 72 is used for masking the right end parts the two display electrode groups 40 located on the right side in FIG. 4. The right end parts of the two display electrode groups 40 located on the left side in FIG. 4 and the left end parts of the two display electrode groups 40 located on the right side in FIG. 4 are not masked.

A size of the masks 71 and 72 is selected in accordance with a size of a screen of the plasma display panel.

For example, the glass substrate of the plasma display panel having a 42 inch diagonal screen 60 has dimensions of approximately 994 mm×585 mm. If the glass substrate is obtained in the “four in one” method, the area of the mother glass plate 111 should be larger than four times the screen (1988 mm×1170 mm). A width of the masks 71 and 72 is approximately 20-30 mm, and a length of the same is approximately the same as the corresponding side of the mother glass plate 111. A thickness of the same is approximately 5±2 mm.

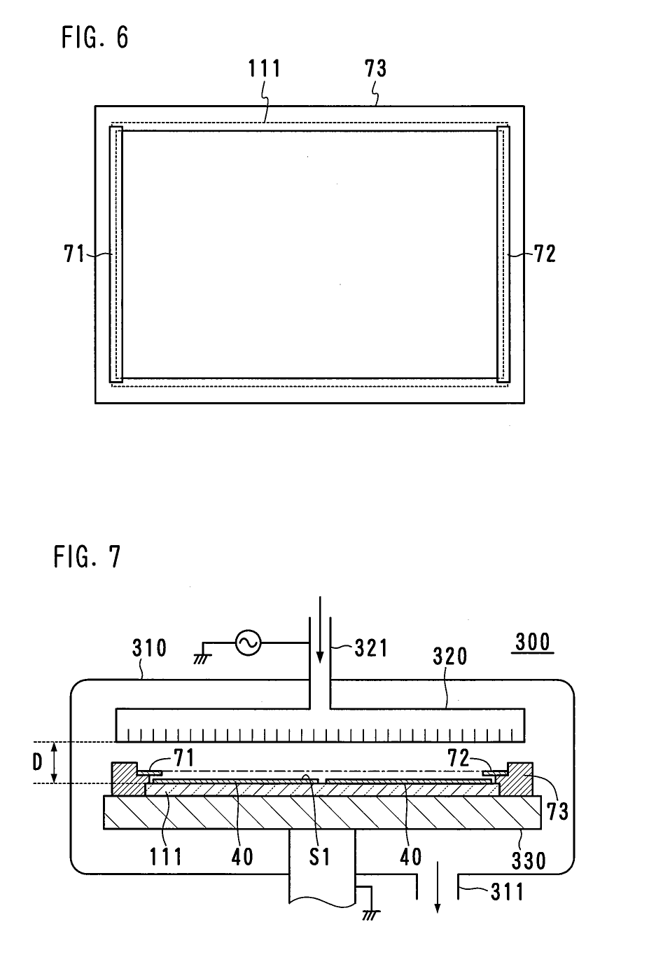

When the masks 71 and 72 are used, they are supported by a rectangular frame 73 as shown in FIG. 6. The frame 73 is a rigid body made of an aluminum alloy having a thickness of approximately 20 mm, and it is larger and thicker than the mother glass plate 111. Thus, the frame 73 is provided with a sufficient mechanical strength as a pressure member for preventing the mother glass plate 111 from being warped by heat.

The dielectric layer is formed by using the masks 71 and 72 in a plasma CVD device 300 shown in FIG. 7, which is a parallel plate type. The plasma CVD device 300 includes a chamber (a reaction chamber) 310 made of a metal container, a shower plate 320 for spouting source gas uniformly in a wide range, a movable base 330 for supporting an object on which a film should be formed, the masks 71 and 72 for the above-mentioned masking, and the frame 73 for supporting the masks 71 and 72.

The shower plate 320 also works as an upper electrode for generating plasma, and the movable base 330 also works as a lower electrode. A heater for heating the object on which the film should be formed is embedded in the movable base 330.

Inside the chamber 310, the masks 71 and 72 are disposed between the shower plate 320 and the movable base 330. In the illustrated state of forming the film, the mother glass plate 111 on which the display electrode groups 40 are formed is placed on the movable base 330, so that the lower faces of the masks 71 and 72 are disposed close to the upper faces of the display electrode groups 40. Plasma is generated in the space between the display electrode groups 40 and the shower plate 320. A distance D between the mother glass plate 111 and the shower plate 320 is selected to be approximately 10 to 20 mm.

The movable base 330 in this example is a lift type that can move up and down. When the mother glass plate 111 is carried in or out, the movable base 330 moves down so as to be separate from the fixed frame 73. The chamber 310 is provided with a mechanism for carrying the mother glass plate 111 in and out, which has an interlock function.

A general outline of the film forming step is as follows.

Air pressure inside the chamber 310 in which the mother glass plate 111 is carried in is reduced to approximately 2.5 to 3.5 Torr, for example, and the mother glass plate 111 is heated to a temperature of approximately 200 to 400 degrees centigrade. In this state, the source gas is led into the chamber 310 through an inlet hole 321 that is formed in the center of the shower plate 320. If the dielectric layer made of silicon dioxide is formed, silane gas (SiH₄) and nitrous oxide (N₂O) are led in as the source gas, for example. The source gas spouts from the shower plate 310 toward the entire of the mother glass plate 111 substantially uniformly.

Concomitantly with leading the source gas, air in the chamber 310 is exhausted through a main outlet hole 311 that is located below the movable base 330. The chamber 310 is provided with a vacuum meter (not shown), and a valve of an exhaust system is controlled in accordance with an output signal of the vacuum meter so that a degree of vacuum inside the chamber 310 can be maintained at a constant value.

Thus, the inside of the chamber 310 is supplied with a constant quantity of source gas, and the plasma generated by a high frequency electric power of 1.5 to 2.5 kW activates the source gas so as to promote the chemical reaction. Then, film material generated by the chemical reaction is deposited on the film forming surface S1 of the mother glass plate 111 so that the dielectric layer is formed. The film forming surface S1 in this example is the upper face of the mother glass plate 111 on which the display electrode group 40 is formed. Strictly speaking, it includes the exposed surface (non-masked surface) of the display electrode group 40 and the surface of the substrate between the electrodes.

In this film forming process, a gas flow is generated when the source gas is led in and air is exhausted. The gas flow is directed from the center to the periphery above the film forming surface S1. Therefore, if the mask is located at the center of the film forming surface S1, the film thickness may be increased locally at the end rims of the mask as described above with reference to FIG. 1(A). On the other hand, unevenness of the film thickness scarcely occurs at the end of the film forming surface S1 in the downstream of the gas flow even if the masks 71 and 72 are disposed. It is because that the film forming surface S1 is located on the upstream side with respect to the masks 71 and 72 as described above with reference to FIG. 1(B). In other words, an influence of the masking at the end part of the film forming surface S1 is smaller than an influence of the masking at the center of the film forming surface S1.

In this example, the mask is not located at the center and its vicinity of the plasma generating space inside the chamber 310 so that uniformity of the film thickness is realized while the masks 71 and 72 are located only at the end part of the plasma generating space for the masking so that a cost necessary for the exposing step of the terminals Xt and Yt can be reduced.

It is desirable to prevent the masks 71 and 72 from touching the display electrode groups 40 in the masking step. It is for preventing damage to the display electrode groups 40. In addition, there is an advantage that the display electrode group 40 will not be oxidized even if the mother glass plate 111 is exposed to the air or a heat treatment carried out in the air after the film forming process, because the terminal parts are coated with a thin dielectric layer by the deposition of the gas that enters the gap between the mask 71 or 72 and the display electrode group 40. If the coating layer is sufficiently thin, e.g., if its thickness is a few thousand angstroms or smaller, external conductors of a flexible printed circuit board or the like can break the thin dielectric layer so as to make electric contacts with the terminal by pressing the external conductors onto the terminal coated with the layer. Therefore, a special process for removing the layer is not necessary. Even if the removing process is necessary, it can be finished in a short time. The masking step in this description is to set the mask to be opposed to the film forming surface S1 so as to make the film thickness be zero or close to zero intentionally, which includes the form of letting the mask touch the film forming surface and the form of preventing the mask from touching the same.

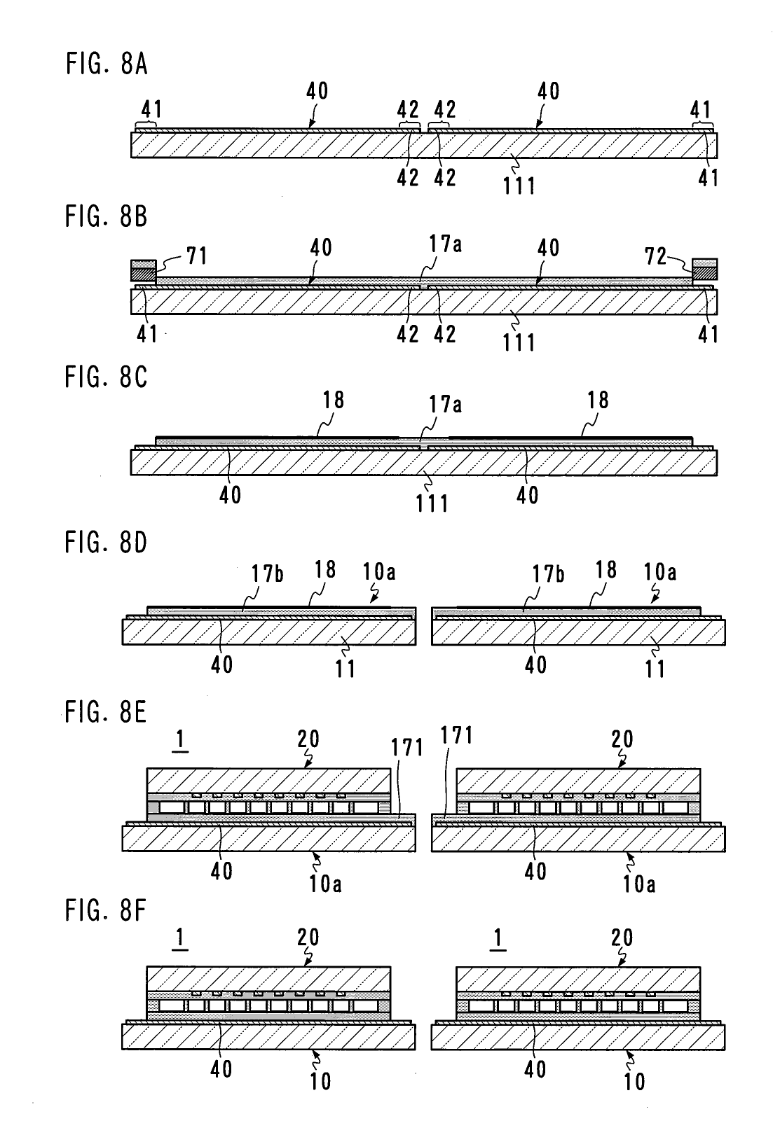

FIGS. 8(A)-8(F) are diagrams showing a manufacturing process of the plasma display panel.

As shown in FIG. 8(A), a plurality of display electrode groups 40 (two of them in FIG. 8(A)) are formed on the mother glass plate 111 for obtaining a plurality of plates. The mother glass plate 111 includes a plurality of substrate members having the same size as the glass substrate 11 of the front plate 10. Each of the display electrode groups 40 includes two terminal parts 41 and 42 for both end parts. The first terminal part 41 is located at the end rim of the mother glass plate 111. The second terminal part 42 is located at the center or its vicinity in the lateral direction of the mother glass plate 111 and is adjacent to the terminal part 42 of the other display electrode group 40. The electrodes to which the terminal parts 41 and 42 correspond are dependent on positions of the corresponding display electrode group 40 on the mother glass plate 111. In this example, the first terminal part 41 of the left display electrode group 40 to be masked includes the terminals Xt of all the row electrodes X of one plasma display panel 1, and the second terminal part 42 includes the terminals Yt of all the row electrodes Y of one plasma display panel 1. On the contrary, the first terminal part 41 of the right display electrode group 40 to be masked includes the terminals Yt of all the row electrodes Y of one plasma display panel 1, and the second terminal part 42 includes the terminals Xt of all the row electrode X of one plasma display panel 1 (see FIG. 3).

As shown in FIG. 8(B), a dielectric layer 17a is formed by a chemical vapor deposition process on the mother glass plate 111 on which the plurality of display electrode groups 40 are formed. The dielectric layer 17a is formed by using the above-mentioned plasma CVD device 300 while the terminal parts 41 located at both end parts of the mother glass plate 111 are covered with the masks 71 and 72.

As shown in FIG. 8(C), magnesia is deposited as the protection film 18 on the dielectric layer 17a, for example. FIG. 8(C) shows an example in which the protection film 18 is formed only in the region that contacts with the discharge gas in the completed state. This film can be obtained by masking when the deposition process is performed, for example. However, without limiting to the illustrated example, the protection film 18 may be formed on the entire surface of the dielectric layer 17a. Since the protection film 18 is sufficiently thin, unnecessary parts thereof can be easily removed later.

As shown in FIG. 8(D), the mother glass plate 111 is divided into a plurality of glass substrates 11. As a result, the dielectric layer 17a is divided into dielectric layers 17b each of which corresponds to each plasma display panel 1.

As shown in FIG. 8(E), the rear plate 20 that is manufactured separately is glued to the front plate 10a obtained in the dividing step. When the front plate 10a and the rear plate 20 are glued to each other to be a unit, one of the terminal parts of the front plate 10a is covered with the dielectric 171 that prevents the terminal part from being connected to an external conductor. When this dielectric 171 is removed, the plasma display panel 1 is obtained as shown in FIG. 8(F).

The procedure of the manufacturing process, which includes the steps of dividing the mother glass plate 111, combining the front plate 10a and the rear plate 20 to be a single unit, and then removing the dielectric 171, has an advantage as follows. The advantage is that the unnecessary dielectric 171 can be removed by a wet etching process that is advantageous for throughput of the step. In addition, the procedure also has an advantage that oxidation of the electrodes can be prevented by the dielectric 171 in the heat treatment for gluing the rear plate 20 to the front plate 10a.

Hereinafter, variations of the masking step in the chemical vapor deposition process will be described.

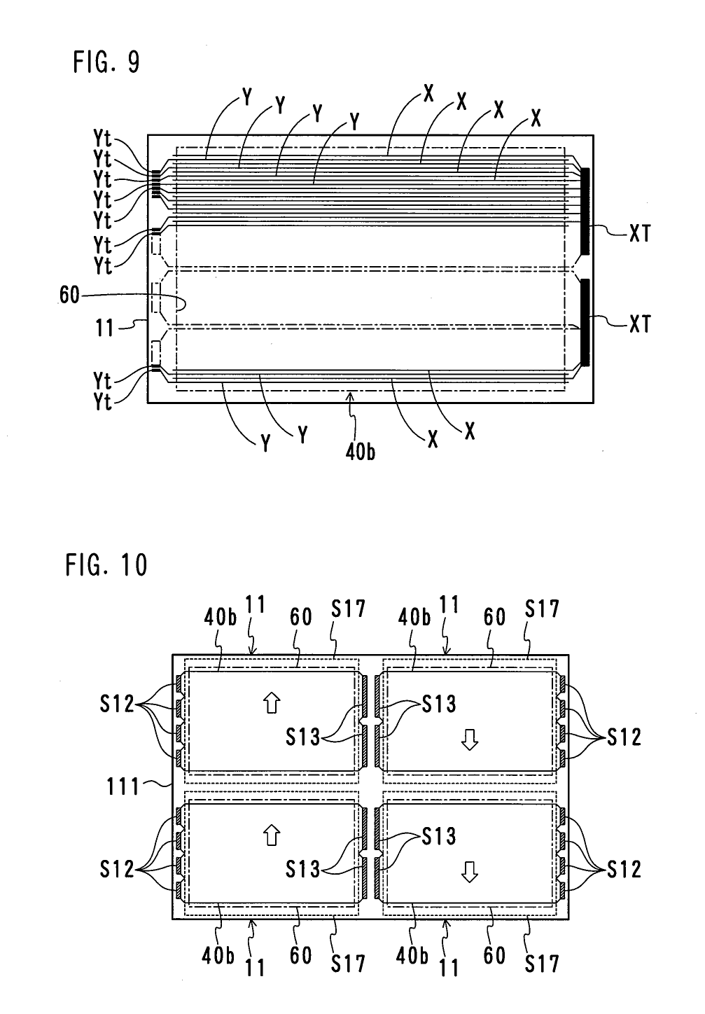

FIG. 9 is a plan view showing a second example of the display electrode pattern. In this display electrode group 40b, the terminal of the row electrode X is a common terminal XT that is connected to a plurality of row electrodes X. In the illustrated example, the row electrodes X are divided into two groups, and total two common terminals XT, each of which corresponds to each of the groups, are disposed on the right end side of the glass substrate 11. Since the common terminal XT is common to the plurality of electrodes, it is naturally larger than the terminal Yt of each row electrode Y (a separate terminal corresponding to one electrode).

FIG. 10 is a plan view showing a region to be exposed in the display electrode group 40b shown in FIG. 9 in the case where the dielectric layers are formed in the “four in one” method.

When the plasma display panel 1 is connected to a driving circuit, the region S12 and the region S13 shown in FIG. 10 must be exposed. In FIG. 10, the mother glass plate 111 includes the four display electrode groups 40b that are formed in two rows. The part where the display electrode group 40b is disposed and the vicinity of the part on the mother glass plate 111 correspond to the front glass substrate 11 of one plasma display panel. The region S12 corresponds to the terminals Yt of the row electrodes Y of each of the display electrode groups 40b, and the region S13 corresponds to the common terminal XT of the row electrodes X of each of the display electrode groups 40b (see FIG. 9).

The feature of this example is that each of the regions to be exposed at the center of the mother glass plate 111 in the lateral direction or its vicinity is the region S13 corresponding to the common terminal XT. In order to obtain this feature, the display electrode groups 40b are arranged so that the vertical directions of the display electrode groups 40b are opposite to each other between the left side and the right side of the mother glass plate 111 when the four display electrode groups 40b are formed. The vertical directions are shown by hollow arrows in FIG. 10.

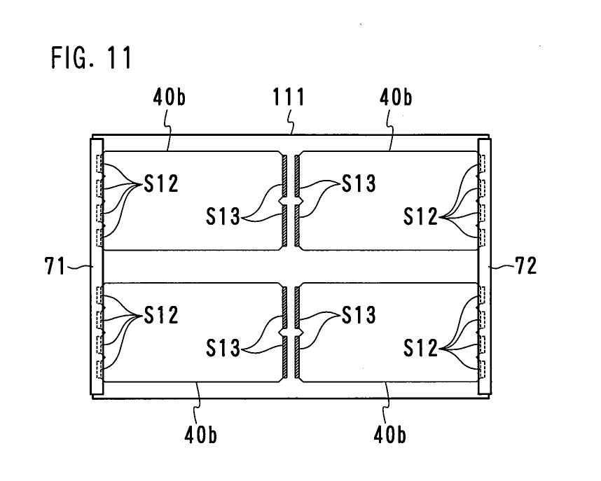

Similarly to the example described above, in this example, the four terminal parts that are close to the center of the mother glass plate 111 are not masked while the other terminal parts are masked out of the total eight terminal parts that are two terminal parts for each of the four display electrode groups 40b. The masking step is performed by using the two masks 71 and 72 as shown in FIG. 11. The forming step of the dielectric layer and the manufacturing procedure after that may be the same as those in the example described above.

Since the terminal parts including the individual terminals Yt are masked while the terminal parts including the common terminals XT are not masked, the unnecessary dielectric 171 covering the electrodes (see FIG. 8(E)) can be removed easily. It is because that electric connection for the plurality of row electrodes X can be performed only if a part of the corresponding common terminal XT is exposed, so that it is not necessary to expose the entire terminal securely unlike the individual terminals. In addition, when the unnecessary dielectric 171 is etched, a wide tolerance of overetching can be permitted.

In the embodiments of the present invention, the mask pattern should be selected in accordance with a shape of the object on which the film should be formed, so it is not limited to the exemplified patterns shown in FIGS. 6 and 11. Without limiting to the “four in one” method, the present invention can be applied to a “one in one” method, in which only one glass substrate is obtained from the mother glass plate or an “n in one” method, in which n (two or more) glass substrates are obtained from the mother glass plate.

The materials of the masks 71 and 72 and the frame 73, the dimensions in a plan view thereof, the thickness thereof, the numbers and locations of the masks 71 and 72, the structure of the film forming device and the like can be selected appropriately within a scope of the present invention in accordance with the spirit thereof.

### INDUSTRIAL APPLICABILITY

The present invention is useful for forming an electrode coating film by a chemical vapor deposition process, and it can be used for manufacturing a flat panel display including a plasma display panel and a liquid crystal panel.

1. A method for manufacturing a flat panel display having a plurality of electrodes and an insulator layer coating the electrodes, the method comprising the steps of:
depositing an insulator by a chemical vapor deposition method on a substrate on which an electrode group having first and second terminal parts is formed, in a state where one of the first and the second terminal parts is masked that is less affected by masking than the other terminal part while the other terminal part is not masked; and
removing a whole or part of the insulator deposited on the terminal part that is not masked.

2. A method for manufacturing a flat panel display including a substrate on which an electrode group having first and second terminal parts and an insulator layer coating the electrode group are fixed, the first terminal part being disposed on one end side of the substrate, and the second terminal part being disposed on the other end side of the substrate, the method comprising the steps of:
forming at least two electrode groups having the same pattern as the electrode group so as to be arranged on a mother substrate for obtaining a plurality of plates including a plurality of substrate members having the same size as the substrate, so that the first terminal part of one of the electrode groups is adjacent to the first or the second terminal part of the other electrode group;
disposing the mother substrate on which the two electrode groups are formed inside a reaction chamber of a chemical vapor deposition device;
depositing an insulator on the mother substrate on which the two electrode groups are formed inside the reaction chamber in a state where the neighboring terminal parts are not masked while the other terminal parts are masked; and
removing a whole or part of the insulator deposited on the terminal parts that are not masked in the two electrode groups.

3. The method for manufacturing a flat panel display according to claim 2, wherein the insulator is deposited on the mother substrate, the mother substrate with the insulator deposited on is divided into a plurality of substrates each of which has an electrode group, and the insulator deposited on the terminal part of each of the resulting substrates is removed.

4. A method for manufacturing a flat panel display including a substrate on which an electrode group having first and second terminal parts and an insulator layer coating the electrode group are fixed, the first terminal part being disposed on one end side of the substrate, and the second terminal part being disposed on the other end side of the substrate, the method comprising the steps of:
forming four electrode groups having the same pattern as the electrode group so as to be arranged in two rows on a mother substrate for obtaining four plates including four substrate members having the same size as the substrate;
disposing the mother substrate on which the four electrode groups are formed inside a reaction chamber of a chemical vapor deposition device;
depositing an insulator on the mother substrate on which the four electrode groups are formed inside the reaction chamber in a state where the four terminal parts that are close to the center of the mother substrate are not masked while remaining four terminal parts are masked among the total eight terminal parts; and
removing a whole or part of the insulator deposited on the terminal parts that are not masked in the four electrode groups.

5. The method for manufacturing a flat panel display according to claim 4, wherein
the first terminal part includes a common terminal that is employed in a plurality of electrodes and is larger in size than a separate terminal employed in one electrode,
the first terminal part of each of the electrode groups is made to be adjacent to the first terminal part of another electrode group when the four electrode groups are formed to be arranged, and
the insulator is deposited on the mother substrate in a state where the first terminal part is not masked while the second terminal part is masked.
